(19) United States
(12) Patent Application Publication
(10) Pub. No.: US 2007/0292029 A1
(43) Pub. Date: Dec. 20, 2007

(54) Cascade plate recognition system

(76) Inventors: Shen-Zheng Wang, Taoyuan City (TW); Hsi-Jian Lee, Hualien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/655,930

(22) Filed: Jan. 22, 2007

(30) Foreign Application Priority Data
Jun. 16, 2006 (TW) 95121548

(51) Int. Cl. G06K 9/00

(52) U.S. Cl. 382/181

(57) ABSTRACT

The present invention discloses a cascade plate recognition system, wherein a compact plate region detection module receives an image, detects the plate area candidates of the image, picks out the sequences having continuous identical pixels from the plate area candidates, performs smearing and filtering on the sequences, extracts connected components from the plate area candidates to obtain compact plate regions, verifies the compact plate regions and outputs the verified compact plate regions; a plate character segmentation and recognition module receives the verified compact plate regions, extracts independent-character regions from each verified compact plate regions, verifies the independent-character regions and recognizes the verified independent-character regions to obtain the information of the plate characters. Thereby, the present invention has the advantages of high accuracy, learning capability and fast realtime operation.

### BACKGROUND OF THE INVENTION

1. Field of the Invention

The present invention relates to a plate recognition system, particularly to a cascade plate recognition system.

2. Description of the Related Art

With economic development, more and more people own cars. However, traffic accidents and vehicle theft also grow with the increasing cars. Those problems and the derivatives thereof beset people and the government deeply. Therefore, vehicle surveillance and management is very important. Although there are speed traps for speedsters or patrol cars/on-street inspections to detect the stolen cars, those activities do not usually achieve sufficient efficacy because of massive manpower shortage. Thus, automatic plate recognition systems are developed to save manpower in the abovementioned tasks.

Generally, a conventional plate recognition system comprises the following subsystems: the image-capturing subsystem, the image-processing subsystem and the plate character segmentation and recognition subsystem. However, the qualities of captured images vary with shooting environments. Traffic signs, advertisement signs, background lighting, and adornments/self-adhesive labels of a vehicle registration plate are likely to interfere with plate recognition. Refer to FIG. 1 a diagram showing a vehicle registration plate. In addition to the character region 4, the vehicle registration plate 2 (usually called plate simply) also has several other parts, such as the frame 6, the screws 8 and the registration location 10. Those non-character regions make the recognition of a plate number harder. Besides, the circuit of the conventional plate recognition system is somewhat complicated. For example, a feedback circuit is used to acquire the image of the entire plate (including the character region and non-character regions) and then recognize the image. Thus, the calculation in the conventional plate recognition system is pretty complicated; the system not only has to process the character region but also has to process other non-character regions. Therefore, the conventional plate recognition system is incapable of processing multiple plate images simultaneously or calculating fast in realtime. Therefore, how to overcome the abovementioned problems and provide superior discrimination, realtime calculation and adaptive learning capability is the key point in developing a plate recognition system.

Accordingly, the present invention proposes a cascade plate recognition system to solve the abovementioned problems.

### SUMMARY OF THE INVENTION

One objective of the present invention is to provide a cascade plate recognition system, wherein the compact plate regions containing only the plate numbers can be fast discriminated from the input image; thus, the succeeding procedures needn't process the top and bottom boundaries of the plate numbers; and thereby, the plate characters in the input image can be fast obtained.

Another objective of the present invention is to provide a cascade plate recognition system, whose cascade framework is characterized in that each module/step receives only the information output by the preceding procedure and passes the processed information backward.

Still another objective of the present invention is to provide a cascade plate recognition system, which can extract the compact plate regions from the input image and can fast obtain the information of the plate numbers with the least calculation.

Further another objective of the present invention is to provide a cascade plate recognition system, which has the advantages of high accuracy, realtime operation, and learning capability.

The cascade plate recognition system according to the present invention comprises: a compact plate region detection module and a plate character segmentation and recognition module. The compact plate region detection module further comprises: a plate-like area generation module, a one-pass plate region extraction module, and a plate verification module, wherein the plate-like area generation module receives an input image and detects plate region candidates in the image; the one-pass plate region extraction module utilizes a one-pass image scanning process to detect the compact plate regions from plate region candidates; via predetermining thresholds, the height and the width of a character and the number of the plate characters, the one-pass plate region extraction module performs an integrated process implying two functions, non-plate candidates suppression and plate candidates smearing, to obtain all candidates of compact plate regions without altering the original source; and the plate verification module verifies the candidates of compact plate regions and outputs the verified compact plate regions. The plate character segmentation and recognition module further comprises: a histogram segmentation module, a projection segmentation module and a character verification module, wherein the histogram segmentation module receives the verified compact plate regions and segments each verified compact plate region into independent-character regions and connected-character regions; the projection segmentation module defines the boundaries of the connected-character regions output by the histogram segmentation module and segments the connected-character regions into the independent-character regions, and all the independent-character regions are thus obtained from each verified compact plate region; and the character verification module verifies the independent-character regions and recognizes the verified independent-character regions to obtain the information of the plate numbers in the input image. The cascade plate recognition system may further comprises a condition-filtering module, which can filter the plate character information output by the plate character segmentation and recognition module with predetermined filtering conditions.

To enable the objectives, technical contents, characteristics and accomplishments of the present invention to be easily understood, the embodiments of the present invention are to be described in detail in cooperation with the attached drawings below.

### BRIEF DESCRIPTION OF THE DRAWINGS

FIG. 1 is a diagram showing a vehicle registration plate;

FIG. 2 is a diagram schematically showing the architecture of the cascade plate recognition system according to the present invention;

FIG. 3 is a diagram schematically showing the architectures of the compact plate region detection module and the plate character segmentation and recognition module of the cascade plate recognition system according to the present invention;

FIG. 4 is a flowchart of the process performed by the one-pass plate region extraction module according to the present invention;

FIG. 5 is a diagram schematically showing a compact plate region obtained according to the present invention;

FIG. 6(a) is a diagram schematically showing independent-character regions obtained from the compact plate region according to the present invention;

FIG. 6(b) is a diagram schematically showing connected-character regions obtained from the compact plate region according to the present invention; and

FIG. 7 is a diagram schematically showing the independent-character regions obtained from the connected-character regions according to the present invention.

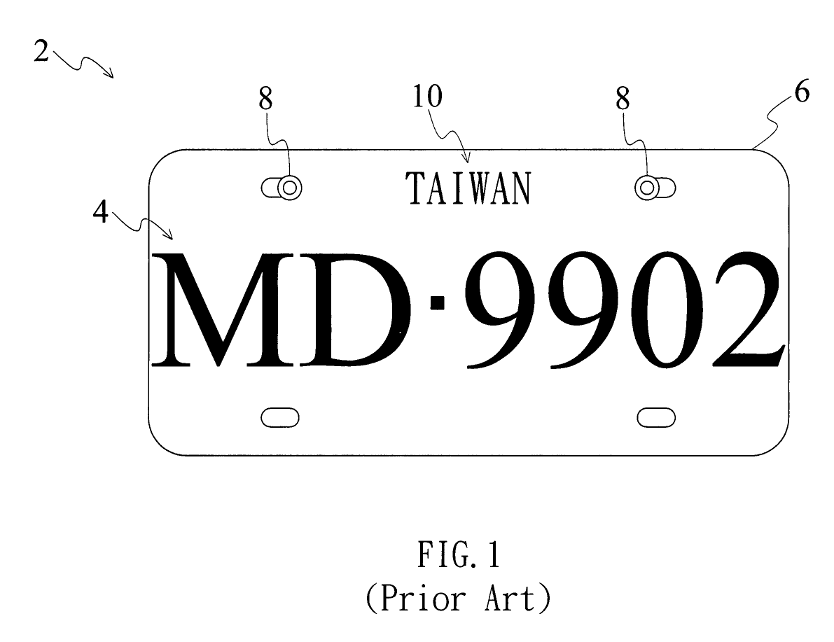

### DETAILED DESCRIPTION OF THE INVENTION

The present invention pertains to a cascade plate recognition system, wherein the compact plate regions bound the top and bottom of plate numbers are discriminated from the input image; thus, the succeeding procedures needn't process the top and bottom boundaries of the plate number; and thereby, the characters in the input image can be fast recognized.

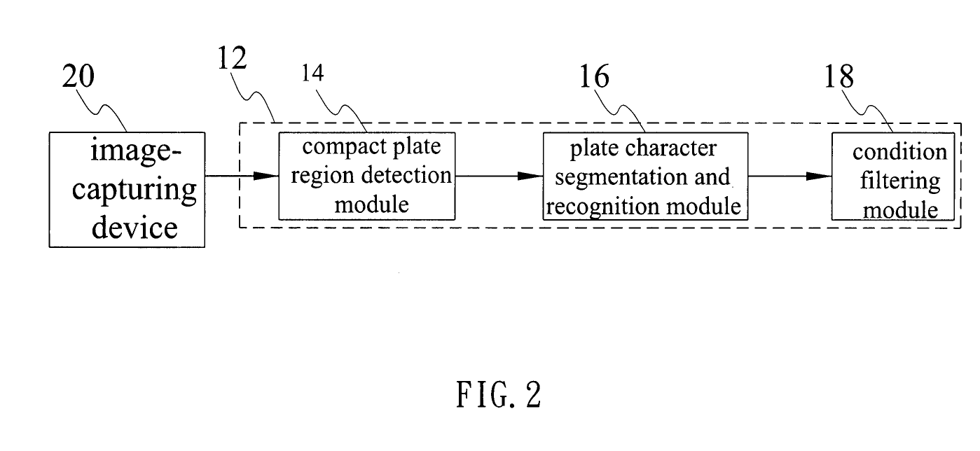

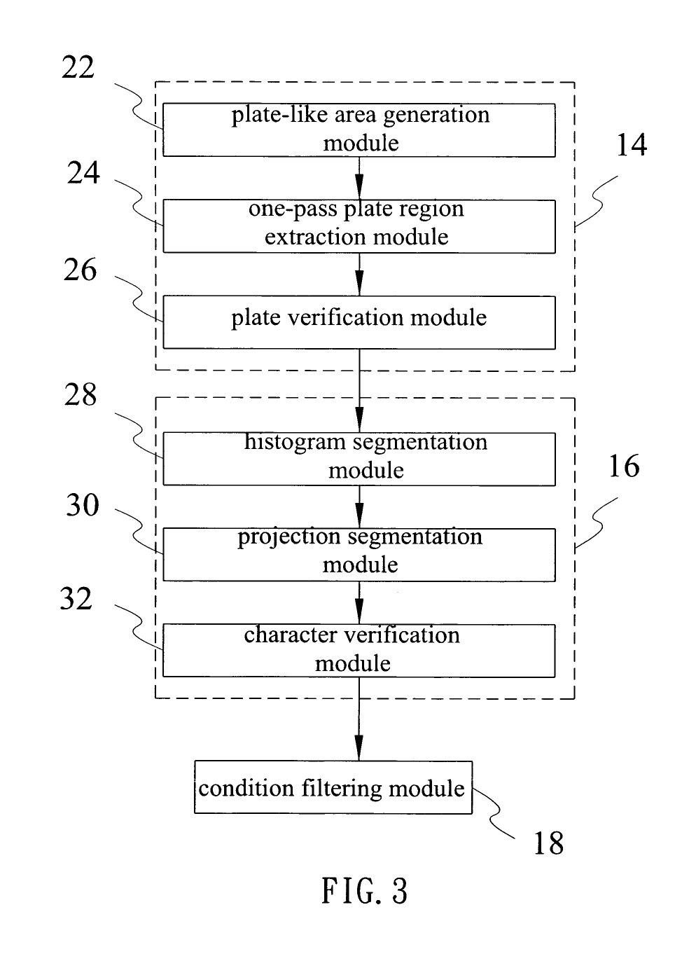

Refer to FIG. 2 a diagram schematically showing the architecture of the cascade plate recognition system according to the present invention. As shown in FIG. 2, the cascade plate recognition system 12 comprises: a compact plate region detection module 14, a plate character segmentation and recognition module 16, and a condition filtering module 18; at least one image-capturing device 20 is used to capture images and input the captured images to the compact plate region detection module 14. Refer to FIG. 3 a diagram schematically showing the architectures of the compact plate region detection module 14 and a plate character segmentation and recognition module 16. As shown in FIG. 3, the compact plate region detection module 14 utilizes a plate-like area generation module 22, a one-pass plate region extraction module 24, and a plate verification module 26 to obtain the compact plates regions from the images input by the image-capturing devices 20. The plate character segmentation and recognition module 16 utilizes a histogram segmentation module 28, a projection segmentation module 30, and a character verification module 32 to process the compact plate regions input by the compact plate region detection module 14.

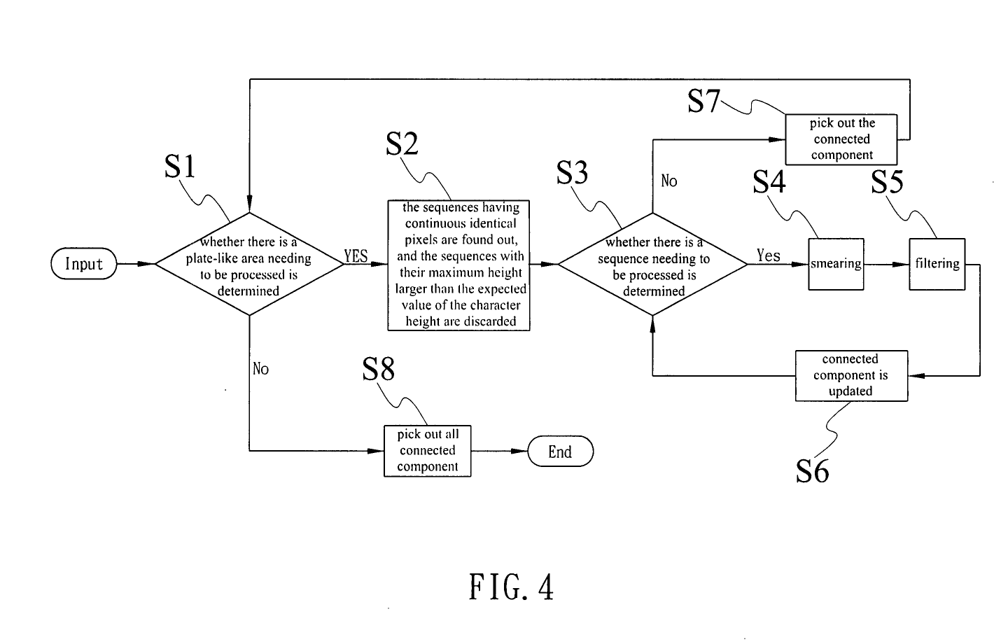

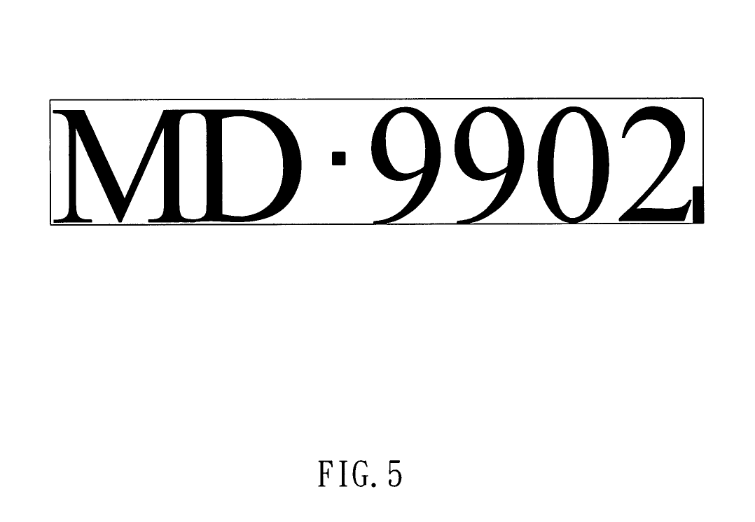

The operation of the cascade plate recognition system 12 is to be described below. The compact plate regions that bound the top and bottom of plate characters are to be firstly obtained, so that the succeeding procedures needn't analyse the top and bottom boundaries of the plate numbers but can directly process the compact plate regions. In the cascade framework of the present invention, the image-capturing device 20 captures an image and sends the image to the compact plate region detection module 14, and the compact plate region detection module 14 will output all the verified compact plate regions. The process performed by the compact plate region detection module 14 is described below. The image input to the compact plate region detection module 14 is processed with a low-level feature analysis algorithm in the plate-like area generation module 22 to obtain plate area candidates. For example, the image is processed with a vertical-gradient operation to obtain a vertical-gradient image, and the vertical-gradient image is processed with a binarization operation according to the Otsu's method, and the area having higher gradient among the vertical-gradient image are determined to be promising plate area candidates. Next, the one-pass plate region extraction module 24 is used to undertake the process shown in FIG. 4. The one-pass plate region extraction module 24 has the predetermined thresholds, the expected width and height of the character and the expected number of plate characters, to undertake the related processing. In Step S1, whether there is a scanning line needing to be processed is determined; if the answer is yes, the process proceeds to Step S2. In Step S2, sequences having continuous identical pixels are found out. In the seeking processing, pixels are seen as non-plate area candidates when their accumulative total of the continuous plate candidate pixels at the same position in the scanned lines are larger than the expected value of the character height because they do not belong to the compact plate regions. A sequence having plate area candidates from the beginning to the end is termed as a “plate run”, otherwise termed as a “non-plate run”. Then, the process proceeds to Step S3; in Step S3, whether there is a plate run needing to be processed is determined; if the answer is yes, the process proceeds to Step S4 and Step S5. In Step S4 and Step S5, smearing and filtering operations are performed on the plate runs needing to be processed, and the independent plate run is integrated into an identical plate run, and the sequence is removed under two conditions: (1) the width of the plate run is longer than the expected value of the plate character width or (2) the width of the plate run is smaller than a threshold and is located between two non-plate runs longer than the expected value of plate character width. Then, the process proceeds to Step S6, and the connected component is updated. Then, the process returns to Step S3 to process another plate run. When there is no plate run needing to be processed in Step S3, the process proceeds to Step S7 to pick out connected components without connecting to any plate run of the scanning line and remove the small connected components to extract compact plate regions, as shown in FIG. 5. Then, the process returns to Step S1 to determine whether there is still another scanning line needing to be processed. When there is no scanning line needing to be processed in Step S1, the process proceeds to Step S8 to pick out all connected components and remove the small connected components to obtain all the compact plate regions, and the process for obtaining the compact plate regions thus ends. Therefore, the one-pass plate region extraction module 24 can extract all compact plate regions in a one-pass image scanning process. Then, the plate verification module 26 verifies the compact plate regions and outputs the verified compact plate regions. Before performing verification, the plate verification module 26 is trained to automatically learn a plurality of features, such as the Haar-like feature, of the compact plate region with a statistical learning method, such as the AdaBoost method. Then, the learned features are used to verify the compact plate regions and discard non-plate ones.

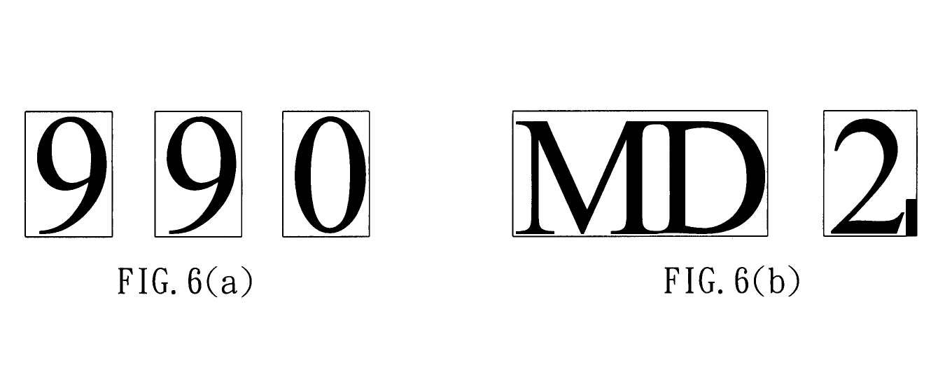

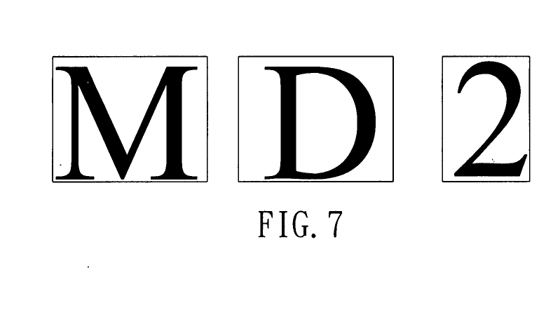

Next, the plate character segmentation and recognition module 16 is used to obtain the information of all the plate characters. Firstly, the plate character segmentation and recognition module 16 utilizes the histogram segmentation module 28 to obtain the histograms of the verified compact plate region, and the histograms are analyzed to segment the compact plate region into the independent-character regions (as shown in FIG. 6(a)) and the connected-character regions (as shown in FIG. 6(b)). For example, the Otsu's method and the peak-valley analysis method may be used to obtain promising thresholds and then obtain all the independent-character regions and all the connected-character regions, wherein the peak-valley analysis method obtains the promising thresholds via the mode initiation process and the peak-valley decision process of the histograms. Next, the projection segmentation module 30 segments the connected-character region into the independent-character regions (as shown in FIG. 7) via defining the boundaries, for example via the peak-valley analysis method. Thereby, all the independent-character regions in the verified compact plate region are obtained. In dealing some characters like 1 or L, the boundary is hard to define. The present invention further utilizes a hypothesis rule and the ratio of length to width to form the candidates of the independent-character regions. Then, the obtained independent-character regions are sent to the character verification module 32 for verification and recognition. Similar to the plate verification module 26, the character verification module 32 is also trained before performing verification. For example, the character verification module 32 is trained to automatically learn a plurality of features of the independent-character regions with a statistical learning method. The learned features are used to verify the independent-character regions and discard the non-character ones. Then, the verified independent-character images are recognized with the OCR (Optical Character Recognition) technology, and the information of the plate characters is thus obtained.

Further, the plate character segmentation and recognition module 16 outputs the information of the plate characters to the condition filtering module 18, and the information of the plate characters is filtered with the predetermined one or a plurality of conditions, and the information of the plate characters meeting the conditions is picked out. When the police intend to detect stolen cars, they merely need to input the filtering conditions into the condition filtering module 18, and the present invention will sort out the cars meeting the input conditions. For example, when the police input the condition that the last three characters of the plate number are 902 or the condition that the plate number is C2-2558, the present invention can sort out the images with the last three characters of the plate number being 902 or the image with the plate number being C2-2558. Therefore, the present invention can perform vehicle surveillance and management with less manpower.

In summary, in the cascade framework of the present invention, each module/step receives only the information output by the preceding procedure and passes the processed information backward, and each module/step only requires a slightly higher accuracy than change. The key constraints of such module/step are a high true positive rate and a relatively low false positive rate, for instance, less than 50%. In other words, all, or almost all, positive targets (plates or characters) must be preserved after they are processed by the rejecter. Each module/step is designed with a minimal computational load and could function faster than 30 fps to satisfy the real-time requirement of the overall system. The plate number in the input image can thus be obtained fast. Further, the present invention has the advantages of realtime calculation and learning capability in addition to high accuracy.

Those described above are the embodiments to exemplify the present invention to enable the persons skilled in the art to understand, make and use the present invention. However, it is not intended to limit the scope of the present invention. Any equivalent modification and variation according to the spirit of the present invention is to be also included within the claims stated below.

What is claimed is:

1. A cascade plate recognition system, comprising:
a compact plate region detection module, further comprising:
a plate-like area generation module, receiving an input image and detecting plate area candidates in said image;
a one-pass plate region extraction module, utilizing a one-pass image scanning process to detect compact plate regions from said plate region candidates, and performing an integrated process implying two functions, non-plate candidates suppression and plate candidates smearing, to obtain all candidates of said compact plate regions without altering the original source via predetermining thresholds, the width and the height of a character and the number of the plate characters; and
a plate verification module, verifying said candidates of compact plate regions and outputting verified compact plate regions; and
a plate character segmentation and recognition module, further comprising:
a histogram segmentation module, receiving said verified compact plate regions and segmenting each said verified compact plate region into independent-character regions and connected-character regions;
a projection segmentation module, defining the boundaries of each said connected-character region and segmenting said connected-character region into said independent-character regions to obtain all said independent-character regions from each said verified compact plate region; and
a character verification module, verifying said independent-character regions and recognizing said verified independent-character regions to obtain the information of the plate characters.

2. The cascade plate recognition system according to claim 1, wherein a low-level feature analysis method is used to filter out non-plate regions and obtain said plate area candidates.

3. The cascade plate recognition system according to claim 2, wherein said low-level feature analysis method utilizes a vertical-gradient operation to obtain a vertical-gradient image and utilizes a thresholding method to perform a binarization operation on said vertical-gradient image to obtain said plate area candidates.

4. The cascade plate recognition system according to claim 1, wherein said one-pass plate region extraction module is used to extract all compact plate regions, which are bound the top and bottom of plate characters, directly.

5. The cascade plate recognition system according to claim 1, wherein said plate verification module is trained to automatically learn a plurality of features of said compact plate regions before performing verification and utilizes said features to verify said compact plate regions.

6. The cascade plate recognition system according to claim 4, wherein said plate verification module is trained with a statistical learning method.

7. The cascade plate recognition system according to claim 4, wherein said features are Harr-like features.

8. The cascade plate recognition system according to claim 1, wherein said histogram segmentation module obtains the histogram of each said verified compact plate region and performs a histogram-segmentation process on said histogram to obtain said independent-character regions and said connected-character regions.

9. The cascade plate recognition system according to claim 8, wherein after said histogram segmentation module obtains said histogram, the Otsu's method and a peak-valley analysis method are used to obtain promising thresholds and then obtain said the independent-character regions and said connected-character regions from each said verified compact plate region.

10. The cascade plate recognition system according to claim 7, wherein said peak-valley analysis method obtains said promising thresholds via a mode initiation process and a peak-valley decision process of said histogram.

11. The cascade plate recognition system according to claim 1, wherein said projection segmentation module utilizes a peak-valley analysis method to define the boundaries of said connected-character regions.

12. The cascade plate recognition system according to claim 11, wherein said projection segmentation module further utilizes a hypothesis rule to form the candidates of said independent-character regions.

13. The cascade plate recognition system according to claim 1, wherein said character verification module is trained to automatically learn a plurality of features of said independent-character regions before performing verification and utilizes said features to verify said independent-character regions.

14. The cascade plate recognition system according to claim 11, wherein said character verification module is trained with a statistical learning method.

15. The cascade plate recognition system according to claim 1, wherein said character verification module utilizes the OCR (Optical Character Recognition) technology to recognize said verified independent-character regions and obtains the information of said plate characters.

16. The cascade plate recognition system according to claim 1, further comprising a condition-filtering module, which has multiplex filtering conditions and filters the information of said plate characters with said filtering conditions.

17. The cascade plate recognition system according to claim 1, wherein at least one image-capturing device is used to obtain said images and send said images to said plate-like area generation module.
